(19) United States
(12) Patent Application Publication
(10) Pub. No.: US 2012/0036143 A1
(43) Pub. Date: Feb. 9, 2012

(54) Method of Operating a Media Playback Device and Media Playback Device

(75) Inventor: Mike SCHOBER, Boeblingen (DE)

(73) Assignee: Daimler AG, Stuttgart (DE)

(21) Appl. No.: 13/195,438

(22) Filed: Aug. 1, 2011

(30) Foreign Application Priority Data
Aug. 6, 2010 (DE) 10 2010 033 673.4

(51) Int. Cl. G06F 17/30

(52) U.S. Cl. 707/758; 707/E17.009

(57) ABSTRACT

A method of operating a motor vehicle media playback device that plays media data files stored on a media memory connected to the media playback device. The media playback device reads data file names or sizes of the data files stored on the media memory, determines media data test values, looks these up in a media data test value storage area of the media playback device and, if one or several media data test values are not found, selects metadata about the media data file, from these generates a dataset and stores it a second storage area, the media data test value being stored in the media data test value storage area and linked with the dataset. If a test value is found, the pertinent dataset is selected from the second storage area and used to produce the selection list shown to a user.

### CROSS REFERENCE TO RELATED APPLICATIONS

The present application claims priority under 35 U.S.C. §119 to German Patent Application No. 102010033673.4, filed Aug. 8, 2010, the entire disclosure of which is herein expressly incorporated by reference.

### BACKGROUND AND SUMMARY OF THE INVENTION

The invention relates to a method of operating a media playback device as well as a corresponding media playback device. The device is designed to playback media data files, stored on at least one media memory connected to the media playback device so as to convey data.

Corresponding methods and devices are known in the state of the art. Particularly in the case of motor vehicles, music playback devices are practically standard. Modern music playback devices usually have CD and/or DVD drives and frequently also interfaces for connection to various external storage media such as pure data memory media and mobile, music playback devices for example. Music playback devices are often designed to playback compressed music files such as MP3, AAC or the like. This enables many music albums to be placed on a single CD or DVD.

Currently, it is problematic that there are no uniform standards for the various storage media and music playback devices with respect to supplying information about the media and no uniform communication standards. Often metadata are linked with music data files storing (e.g., MP3 data files employ so-called ID3 tags), not only the file name further information about the respective music title, but also other information such as artist, album, length of the piece, music direction, etc. Some music playback units store such information in a database or library. Some music playback units again only permit access to certain information and no direct access to the media memory located therein. Contingent on what has been stated above it is currently difficult to enable a music playback device to be operated with ease by a user. More particularly, it is difficult to offer uniform selection over various connected media, for example a CD inserted in a drive and a mobile music playback unit connected to an interface. At present, the respective storage medium must initially be selected and then the respective music piece.

The state of the art also shows first database-based systems, wherein a database, which stores information about the media data files stored on the storage media, and can thus supply the user with additional information and choices are provided in the music playback device fitted to the motor vehicle. If the known systems find that the storage media have been altered since previous use, the database is reconstructed, which requires all metadata of all media data files present on the storage media to be selected. This can consume a great deal of time, dependent on the storage volume and selection speed which the storage media and music playback device permit, when no media can be played back from the storage media. This is very inconvenient.

Exemplary embodiments of the present invention provide a method and a media playback device of the type mentioned at the beginning so that the drawbacks of the solutions known from the prior art are at least partly overcome. Exemplary embodiments of the present invention provide a method as well as a media playback device allowing fast and convenient operation.

The inventive method of operating a media playback device, which is designed to playback media data files, that are stored on at least one media memory connected to the media playback device so as to convey data, involves showing a user of the device a selection list, which is produced using information from the media memory.

Media data files in the inventive sense more particularly can contain sound as well as picture and also moving picture information to be played back.

A data-conveying connection in the inventive sense can be through drives installed in the media playback device, for example DVD or CD drives, wireless or wire-bound networks and/or standard interfaces such as memory card slots or USB interfaces and/or proprietary interfaces such as to mobile media playback devices. All these types of data-conveying connections can be provided together or a selection of these, for example a DVD drive and a connection to a mobile media playback device with proprietary interface.

The inventive selection list can be a single-line or multiple line selection list, depending on the design of the display device. The selection list can allow selection according to various criteria, for example, in the case of music, according to artist, direction, album etc. The selection list can be graphically designed.

The selection list is generated according to the invention inter alia by way of the following process steps:

the media playback selects data file names and/or sizes of the data files stored on the media memory,

media data test values are determined from data file names or sizes in each case,

the media data test values are looked up in a media data test value storage area of the media playback device.

With this step two cases can occur. The media data test values cannot be stored in the media data test value storage area, that is to say one or several media data files are new and not yet recorded (case A) or the media data test values already exist, that is to say the corresponding media data files have already been recorded (case B).

In case A), if one or several media data test values are not found, according to the invention

metadata about the media data file are selected, from which metadata a dataset is generated and stored in a second storage area, the media data test value is memorized in the media data test value storage area and linked with the dataset;

In case B), if a test value is found, according to the invention

the pertinent dataset is selected from the second storage area, and

the dataset is used to produce the selection list.

With the inventive method datasets matching the media data files can be stored in the media playback device, so that information relevant to the targeted application can be made available for selection. Furthermore it may be possible to prevent, after each alteration on the media memory, all media data files having to be re-loaded. By creating and storing the test values, for example hash values all data files, which are new or altered and new metadata of which have to be re-entered, can be quickly identified in the device. In the case of new media data files on the media memory the selection list can then be produced very much faster than up until now.

The use of a database of this type also permits a uniform selection list to be made available by way of several different media memories connected to the media playback device. For example entries occurring twice can be segregated automatically, which increases the clarity of the selection list.

More particularly the selection list can be adapted for individual users. In this way better consideration can be given to the various requirements and skills of the user. Some users do not need certain options or are confused by too great an abundance of options.

In accordance with a possible refinement of the inventive method the metadata are selected from the media data file itself or from a media library on the media memory. Some types of media have metadata stored in the data file itself, for example ID3 tags in the case of MP3 data files. Nevertheless some media playback devices themselves have a database, which stores metadata and possibly additional data. In this case access to the metadata is equally possible via the database.

A first independent object of the invention relates to a method of operating a media playback device, which is designed to playback media data files, that are stored on at least one media memory connected to the media playback device so as to convey data, in which a user of the device is shown a selection list, which is produced using information from the media memory.

Media data files in the inventive sense more particularly can contain sound as well as picture and also moving picture information to be played back.

A data-conveying connection in the inventive sense more particularly can be through drives installed in the media playback device, for example DVD or CD drives, wireless or wire-bound networks and/or standard interfaces such as memory card slots or USB interfaces and/or proprietary interfaces such as to mobile media playback devices. All these types of data-conveying connections can be provided together or a selection of these, for example a DVD drive and a connection to a mobile media playback device with proprietary interface.

A selection list in the inventive sense can be a single-line or multiple line selection list, depending on the design of the display device. The selection list can allow selection according to various criteria, for example in the case of music according to artist, direction, album etc. The selection list can be graphically designed.

According to the invention the media playback device:

determines a media memory test value for the respective media memory, and

looks up the respective media memory test value in a media memory test value storage area of the media playback device.

With this step two cases can occur. The media memory test values cannot be stored in the media memory test value storage area, that is to say the media memory is new and not yet recorded (case C) or the media memory test values already exist, that is to say the corresponding media memory has not been altered since the previous connection or insertion (case D).

In accordance with step C), if the respective media memory test value is not found, the media playback device selects metadata about the media data files stored on the respective media memory, stores these in a second storage area and for the respective media memory test value produces a list of the media data files present on the respective media memory and stores these in a fourth storage area. This list can then be used for producing the selection list. The media memory test value itself is stored in a media memory test value storage area.

In accordance with step D), if the respective media memory test value is found, the media playback device skips the selection of metadata and, for producing selection list, uses the list for this media memory test value in the fourth storage area.

More particularly, the list in the fourth storage area can be linked with the metadata in the second storage area. Then the selection list can be produced while selecting the metadata stored in the second storage area linked with the list in the fourth storage area.

By way of the inventive method a selection of metadata can be avoided in cases where the media memory has not been altered since the previous connection. This arises relatively frequently, for example in the case of media, which can only be described once or depending on customary use in the case of mobile media playback devices, on which frequently alterations to the media data files are only occasionally made.

In accordance with a first possible refinement of the inventive method the media memory test value for the respective media memory is determined from the data file system, a data file list present on the media memory or a media library. These data take up relatively little storage space, but nevertheless are indicators of alterations on the media memory. They can therefore be selected quickly. In addition, if present on the media memory, a media memory identifier is also used.

In accordance with a further possible refinement the first concept of the invention and the second concept of the invention are combined. In this way the inventive method can be further accelerated, if no alterations to the media memory have been made. Only in the case of alterations are the metadata of new media data files entered. In this case more particularly only the list in the fourth storage area can be updated.

In accordance with a further possible refinement of the two inventive methods usage information is stored in the dataset. Usage information can be popularity, frequency of use, last opening, stop position when last played etc. This provides convenient auxiliary functions to the user who can, for example, continue to play an interrupted title at the corresponding place.

A further independent object of the invention relates to a computer program product with a data memory, on which a program is stored that is executed on a processor implementing the method in accordance with the concept of the invention described above.

A further independent object of the invention relates to a media playback device, which has at least one interface to the data communication with a media memory. According to the invention at least one test value storage area is provided for storing test values for the media data files stored on the media memory and at least one metadata storage area for storing metadata about the media data stored on the media memory. This allows one or several selection lists of the media data files stored on the media memories to be produced very quickly.

In accordance with a first possible refinement a media memory test value storage area is provided for storing test values for the respective media memory and/or a fourth storage area for storing a list of media data files stored on a media memory. In this way production of the selection list or lists can be further accelerated.

In accordance with a further possible refinement a processor is provided, which is designed to determine media memory test values and/or media data file test values.

In accordance with a further possible refinement the inventive device is designed to carry out the inventive method described above. More particularly this can be implemented by a device with a computer program product in accordance with the concept of the invention described above.

A final independent object of the invention relates to a motor vehicle with a media playback device in accordance with the concept of the invention described above.

Other objects, advantages and novel features of the present invention will become apparent from the following detailed description of one or more preferred embodiments when considered in conjunction with the accompanying drawings.

### BRIEF DESCRIPTION OF THE DRAWINGS

The invention is described on the basis of an exemplary embodiment, wherein schematically:

FIG. 1 is an illustration of an inventive media playback device;

FIG. 2 is an illustration of the inventive operative sequence;

FIG. 3 is a time-axis illustration of the inventive operative sequence;

FIG. 4 is an illustration of the organization of the media data in the inventive media playback device; and

FIG. 5 is an illustration of the linkage of the media data in the inventive media playback device with test values.

### DETAILED DESCRIPTION OF THE DRAWINGS

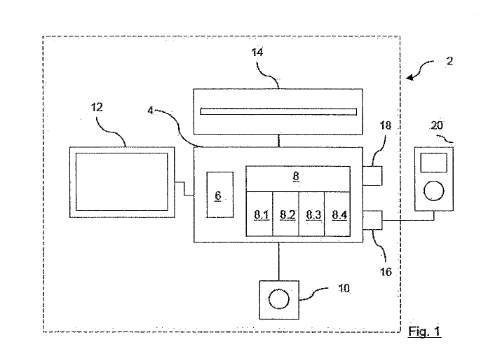

FIG. 1 shows, framed by a broken line, an inventive media playback device 2.

The media playback device 2 has a computing unit 4 with a processor 6 and a memory 8. The memory 8 is divided into several storage areas 8.1, 8.2, 8.3, 8.4. An input device 10 and a screen 12 are connected to the computing unit 4. In addition, a drive 14, for example a CD, DVD or BluRay drive is provided. The media playback device 2 also has interfaces 16, 18, which serve to connect external media memories. A mobile media playback device 20 is attached to the interface 16.

The computing unit 4 has various functions. Computing unit 4 is responsible for all media playback functions of the media playback device 2, for example decoding music conveyed in compressed format, processing input functions, controlling or adjusting the playback devices such as loudspeakers or screens, processing information and also determining test values, which show the state of media playback devices 20 and/or media data files.

The memory 8 is divided into four storage areas 8.1, 8.2, 8.3 and 8.4. Storage area 8.1 stores media data test values. Media data test values are generated by examining data file names and sizes using a hash function. The generation of media data test values is relatively fast because these data are easily available in the media memory.

Storage area 8.2 distributes a dataset, which contains additional information about the media data files. If the media data file for example is a music file, such additional information can be data concerning artist, album, title, music direction and the like. Furthermore this graphic information can be pictures of the music albums. Also, usage information such as previous use, frequency of use, stop position and the like can be stored in the storage area 8.2.

Storage area 8.3 stores test values for media memory such as the mobile media playback device 20. Such a test value can be generated inter alia from the data file system of the media memory 20. Furthermore, the test value could be generated from a data file list or a database on the respective media memory, through alteration information stored on the memory or media memory identifiers such as serial numbers or the like. By means of this information, the inventive media playback device 2 can very quickly detect whether the respective media memory has remained unaltered since the previous connection or otherwise. If the media memory has not been altered, the media data files themselves possibly do not have to be checked again.

Storage area 8.4 stores lists, which create a linkage between the media memory test values of storage area 8.3 and the datasets from storage area 8.2. Thus, when connecting or inserting a specific unaltered media memory, a selection list can be produced very quickly, which can then be made available to the user.

Such a selection list can be displayed on the screen 12.

FIG. 2 schematically shows the inventive operative sequence.

After inserting or connecting a media memory 20, the inventive media playback device 2 reads the data file system of the media memory 20. During this operation the data files and their sizes stored on the media memory 20 are selected from the data file list of the data file system. From these values the media playback device generates a test value for each media title. The test value is looked up in the storage area 8.1.

If the test value is present in the memory area 8.1, the media playback device 2 selects metadata from the storage area 8.2 and possibly additional data, for example associated title pictures or the like, from the storage area 8.2 and uses these data to produce the selection list for the user.

If the test value is not present in the storage area 8.1, the media playback device 2 selects metadata from the not-recorded media data file and from these produces a dataset, which is stored in the storage area 8.2. Possibly further information about the respective media data file is recorded, for example via the Internet or user inquiry.

As soon as all media data files are recorded, the selection list can be produced for the user.

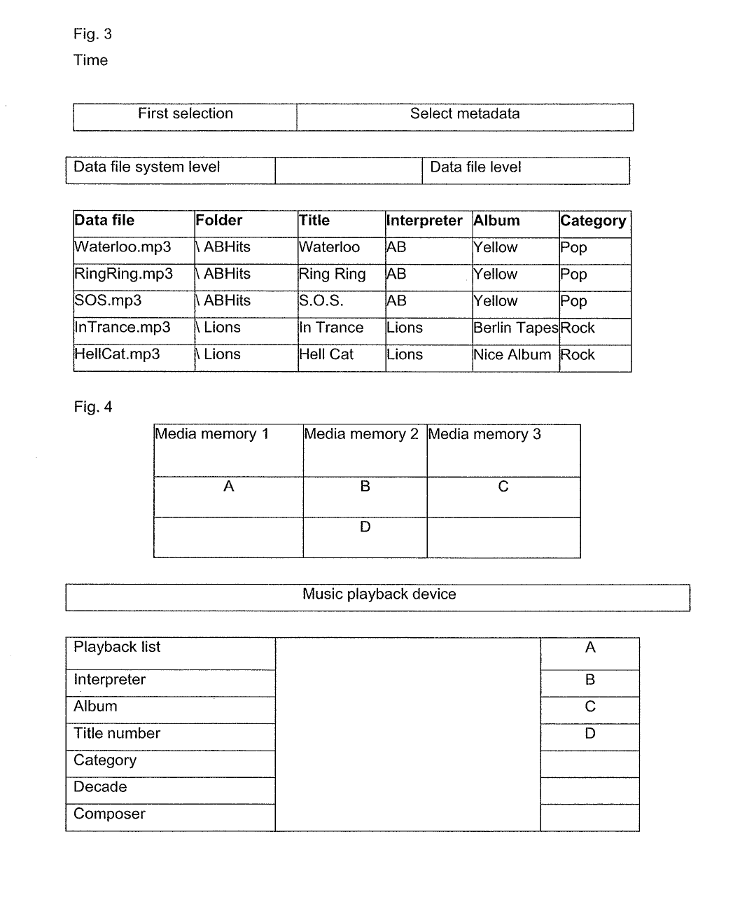

FIG. 3 shows the method in a time-axis illustration.

It can be determined very quickly in a first step by reading on a data file system level as a result of test value comparison whether all titles are recorded. This rarely takes more than 30 seconds are necessary.

Only if not all files are recorded, metadata must be entered by opening the non-recorded titles on a data file level. Usually this takes no more than 2 minutes.

Even after the first step a partially reduced selection list can be offered to the user, with which he or she can already permit media to be selected and played. After the second step has been completed information is then available to the user.

FIG. 4 shows an illustration of the organization of the media data in the inventive media playback device 2.

Various music albums, to which the media playback device 2 simultaneously has access at a given time, are stored on various media memory connected to the media playback device 2.

The user can be shown all these music albums, irrespective of the media source, sorted in a common selection list and offered for selection.

The user has the choice of a variety of display and sorting options. Thus he or she can choose, inter alia, according to category, artist, title and more.

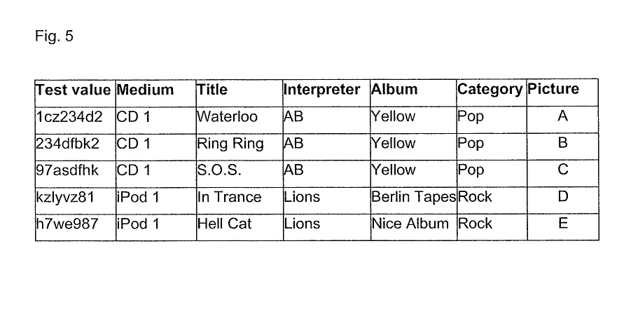

FIG. 5 shows the allocation of test values (hash value) from the storage area 8.1 to metadata from the storage area 8.2. Additional information can be allocated to each test value, as for example the medium, on which the media data file is stored, title, album, artist, an album picture, usage information and much more.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method of operating a motor vehicle media playback device that plays media data files stored on at least one media memory connected to the media playback device so as to convey data, wherein a user of the media playback device is shown a selection list, which is produced using information from the media memory, the method comprising:
selecting, by the media playback device, data file names or sizes stored on the media memory;
determining, by the media playback device, media data test values from data file names or sizes; and
looking-up, by the media playback device, the media data test values in a media data test value storage area of the media playback device,
wherein when one or several media data test values are not found, the media playback device selects metadata about the media data file, generates from the metadata a data record and stores the generated metadata in a second storage area, wherein the media data test value are stored in the media data test value storage area and linked with the data record;
wherein when a test value is found, the media playback device selects a pertinent dataset from the second storage area and uses the dataset to produce the selection list.

2. The method according to claim 1, wherein the metadata are selected from the media data file(s) or from a media library on the media memory.

3. A method of operating a motor vehicle media playback device that plays media data files stored on at least one media memory connected to the media playback device so as to convey data, wherein a user of the media playback device is shown a selection list, which is produced using information from the media memory, the method comprising:
determining, by the media playback device, a media memory test value for the respective media memory;
looking-up, by the media playback device, the respective media memory test value in a media memory test value storage area of the media playback device,
wherein when the media memory test value is not found, the media playback device selects metadata about the media data files stored on the media memory and stores the selected metadata in a second storage area and in the media memory test value storage area, produces a list of the media data files present on the respective media memory for the respective media memory test value and stores the produced list in a fourth storage area, and uses the produced list as the selection list,
wherein when the respective media memory test value is found, the media playback storage devices skips the selection of metadata and produces the selection list using the list for this media memory test value stored in the fourth storage area.

4. The method according to claim 3, wherein the media memory test value for the respective media memory is determined from a data file system, a data file list present on the media memory or a media library.

5. The method according to claim 3, wherein when the media memory test value is not found, selection of metadata about the respective media data file comprises one of:
the media playback device selecting metadata about the media data file, generating from the metadata a data record and storing the generated metadata in a second storage area, wherein the media data test value are stored in the media data test value storage area and linked with the data record; and
the media playback device selecting a pertinent dataset from the second storage area and using the dataset to produce the selection list.

6. The method according to claim 3, wherein usage information is stored in the dataset.

7. A non-transitory storage medium storing a computer program, which when executed by a processor of a media playback device, causes the processor to:
select data file names or sizes stored on the media memory;
determine media data test values from data file names or sizes; and
look-up the media data test values in a media data test value storage area of the media playback device,
wherein when one or several media data test values are not found, metadata about the media data file is selected, a data record is generated from the metadata, and the generated metadata is stored in a second storage area, wherein the media data test value are stored in the media data test value storage area and linked with the data record;
wherein when a test value is found a pertinent dataset is selected from the second storage area and uses the dataset to produce the selection list.

8. A media playback device, comprising:
a processor;
a media memory data conveyance interface, coupled to the processor, to convey data with a media memory; and
a memory, coupled to the processor, which includes a test value storage area storing test values for media data files stored on the media memory and a metadata storage area storing metadata about the media data on the media memory.

9. The media playback device according to claim 8, wherein the memory includes a media memory test value storage area storing test values for the respective media memory or a fourth storage area storing a list of media data files stored on a media memory.

10. The media playback device according to claim 8, wherein the processor is configured to determine media memory test values or media data file test values.
